(19) United States
(12) Patent Application Publication
(10) Pub. No.: US 2021/0166485 A1
(43) Pub. Date: Jun. 3, 2021

(54) METHOD AND APPARATUS FOR GENERATING AUGMENTED REALITY IMAGES

(71) Applicant: HOLOME TECHNOLOGIES LIMITED, Greater London (GB)

(72) Inventors: Denis ISLAMOV, Greater London (GB); Janosch AMSTUTZ, Greater London (GB); Zuheb JAVED, Greater London (GB)

(21) Appl. No.: 17/045,443

(22) PCT Filed: Apr. 5, 2019
(86) PCT No.: PCT/GB2019/051007

§ 371 Date: Oct. 5, 2020

(30) Foreign Application Priority Data
Apr. 5, 2018 (GB) 1805650.7

(51) Int. Cl. G06T 19/00; G06T 7/70

(52) U.S. Cl. CPC G06T 19/006; G06T 7/70

(57) ABSTRACT

The present disclosure includes a method of providing an augmented reality image comprising recording a subject image using a recording device, extracting and refining the subject image from the image using processing techniques, and then providing, either through live streaming, download, or other means, the extracted subject image to a display device to overlay over real world images. The method uses a novel algorithm to tether the image in place and rotate it as the display device moves, significantly reducing the size and complexity of the image required.

The present application relates to a method, apparatus and program for generating augmented reality images. More specifically, the invention relates to a method of shooting and processing video and then displaying that video as a computer-generated overlay in augmented reality, and in particular to displaying video of a human being as a computer generated overlay in an augmented reality display.

### BACKGROUND

Augmented Reality (AR) refers to a technology where computer generated content, for example overlays, are integrated with images of a real-world environment. Overlays are commonly a visual, e.g., image, representation of text, icons, graphics, video, pictures or 3D models.

In general, this AR display is made possible by electronic devices comprising processor, display, sensors and input devices. These electronic devices include tablet computers, smartphones, eyewear, such as smartglasses, and head-mounted displays. The devices may be configured to provide an AR display by displaying to a user augmented reality objects or video in a display of the field of view of a camera of the device.

Generally, augmented reality systems insert virtual objects over real-world images, for example by overlaying a video stream with a two-dimensional or three-dimensional rendering of a virtual object. In one example, augmented reality is used to superimpose virtual characters over a video feed of a real scene.

In other examples, virtual objects are created to have a person's appearance. Unfortunately, conventional methods for creating these human images in AR are time-consuming and expensive, serving as a bottleneck to widespread adaptation by consumers and smaller businesses. Additionally, these conventional methods create an imperfect image that the human brain immediately recognises as artificial, lessening the effectiveness of the message the virtual object is delivering. In many cases this recognition that the AR image is artificial triggers the psychological ‘uncanny valley’ effect, causing a negative emotional response which further lessens the effectiveness of the message the virtual object is delivering.

The current method for creating virtual objects that resemble a person involve recording the subject person using multiple cameras and then attaching those images to a 3D mesh. This requires a complex professional setup involving up to 120 cameras to film, and the problems aligning the different images used make it easy for viewers to spot that they are looking at a virtual object. Furthermore, the number of images used and the complexity of the mesh result in a data file size that is too large for streaming or use on mobile devices, and reducing the amount of data to an amount that is practicable for use results in the image quality being reduced below what is acceptable to viewers. In addition, existing AR systems are often marker-based, using a visual registration system to overlay information based on known markers in the real environment. This restricts the applicability of the technology to predetermined locations.

The high costs of creating these virtual models of humans and the equipment required to do so, and the large file sizes of the objects created, are roadblocks to widespread and ubiquitous creation and use of human holograms in augmented reality. Therefore, it may be desirable to provide a novel method and apparatus for inexpensively capturing video of live objects. Furthermore, it may be desirable to provide a novel method that achieves a far higher resolution, increasing the level of realism and believability of the hologram. Moreover, it may also be desirable to provide a novel method of capturing and processing the images that results in a significantly decreased file-size that makes it feasible to access these images in high quality on a mobile device. In addition, it may also be desirable to provide a novel method of processing that allows these objects to be streamed live to devices as they are being filmed. Additionally, it may also be desirable to provide a novel method of processing that allows there objects to be streamed live to devices as they are being filmed. Additionally, it may also be desirable to provide a novel method of tethering the hologram to the floor so that viewers can watch it in any location.

The embodiments described below are not limited to implementations which solve any or all of the disadvantages of the known approaches described above, or provide any of the desirable outcomes identified above.

### SUMMARY

In general, the improved methods and systems described herein involve the capturing, processing and transmitting of video so that an augmented reality hologram can be generated on the user's device.

The present disclosure relates generally to method, apparatus and program for use in generating augmented reality human assets. More specifically, the invention relates to the method of shooting and processing video and then displaying that video as a human asset in augmented and virtual reality.

The inventors have sought to provide a novel method for generating an augmented reality hologram free from the cost, file size, and tethering problems in current methods. In the present disclosure the term ‘hologram’ is used to refer to computer generated image overlay data, although it will be appreciated that such overlays do not correspond to holograms as conventionally understood, but rather to pseudo-holograms that have a 3 dimensional hologram-like appearance when viewed in the overlaid images.

According to one aspect of the invention there is provided a method of generating an augmented reality image. The method comprises capturing a first set of image data, processing the image data to extract a specific portion of the data, and then subsequently overlaying the extracted data portion on a second set of image data. The processing step may involve removing undesirable aspects and visual artefacts within the first image data set. The method may be carried out in a mobile client device, or may be carried out in a separate server where the processed image data is stored and is transmitted to a display device prior to the subsequent overlaying step.

The extracted portion of the first set of image data may represent a target object that is to be removed from a background portion of the image data. The presence of the background portion of the image data may introduce visual artefacts within the extracted portion, for example reflected light from the background on the target object or shadows on the target object. The processing step of the method may involve various steps necessary to remove these visual artifacts. In the example where the background comprises a colour background, such as a green screen, then the processing step of the method may involve steps to remove the effects of the colour background from the first image data.

Where the method is carried out in a mobile client device, the augmented reality image data that is provided can be processed and streamed sufficiently quickly, that the augmented reality image can be overlaid onto the image background whilst it is being processed and streamed.

According to another aspect of the invention, there is provided a method for the display device to maintain a relative position and scale of an augmented reality image within its overlaid background environment, as seen by a user of a display device displaying the augmented reality image, whilst the position of the display device is changed. The method involves anchoring the augmented reality image to a plane within the background environment, and changing the angle and pitch of the augmented reality image based on the movement of the display device.

This is advantageous as it ensures that the augmented reality hologram will always face the user regardless of the orientation of the device, and hence this means that it is not necessary to display a ‘true 3D’ holographic image since the back of the hologram will not be seen by the user. In addition, the perspective of the hologram is maintained and hence a more realistic simulation of the augmented reality image is provided.

This Summary is provided to introduce a selection of concepts in a simplified form that are further described below in the Detailed Description. Within the scope of this application it is expressly intended that the various aspects, embodiments, examples and alternatives set out in the preceding paragraphs and/or in the following detailed description and drawings, and in particular the individual features thereof, may be taken independently or in any combination. That is, all embodiments and/or features of any embodiment can be combined in any way and/or combination, unless such features are incompatible. Many modifications may be made to the examples described herein without departing form the scope of the present invention.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a first aspect, the present disclosure provides a method of generating a video image, the method comprising: capturing a first set of video image data of a region of record including an object; processing the first set of video image data to extract a portion of the video image data including the object; sending the portion of the video image data to a display device; combining the portion of the video image data with a second set of video image data to form a composite video image including the object; and displaying the composite video image on the display device; wherein the portion of the video image data is displayed in the composite video image with an apparently fixed position within the second set of video image data and a variable orientation, the variable orientation being based at least in part on movement of the display device.

In a second aspect, the present disclosure provides a method of displaying a video image, the method comprising: receiving first video image data; combining the first video image data with a second set of video image data to form a composite video image; and displaying the composite video image on a display device; wherein the first video image data is displayed in the composite video image with an apparently fixed position within the second set of video image data and a variable orientation, the variable orientation being based at least in part on movement of the display device.

In a third aspect, the present disclosure provides a system for generating a video image, the system comprising: a video image capture device arranged to capture a first set of video data of a region of record including an object; image processing means arranged to process the first set of image data to extract a portion of the image data including the object; sending means arranged to send the portion of the image data to a display device; the display device comprising: combining means arranged to combine the portion of the image data with a second set of image data to form a composite video image including the object; and display means arranged to display the composite video image on the display device; wherein the portion of the image data is displayed in the composite image with an apparently fixed position within the second set of image data and a variable orientation, the variable orientation being based at least in part on movement of the display device.

In a fourth aspect, the present disclosure provides a video image display device comprising: receiving means arranged to receive first video image data; combining mean arranged to combine the first video image data with a second set of video image data to form a composite video image; and display mean arranged to display the composite video image; wherein the display device is arranged to display the first video image data in the composite video image with an apparently fixed position within the second set of video image data and a variable orientation, the variable orientation being based at least in part on movement of the display device.

In a fifth aspect, the present disclosure provides a computer program which, when executed by a processor of a video image display device, causes the device to carry out the method according to the fourth aspect.

In a sixth aspect, the present disclosure provides a method of two-way communication, the method comprising: using a first video image capture device associated with a first display device to capture a first set of video image data of a first region of record including a first object; processing the first set of video image data to extract a first portion of video image data including the first object; sending the first portion of the video image data to a second display device; at the second display device, combining the first portion of video image data with a second set of video image data to form a first composite video image including the first object; and displaying the first composite video image on the second display device; wherein the first portion of video image data is displayed in the first composite video image with an apparently fixed position within the second set of video image data and a first variable orientation, the first variable orientation being based at least in part on movement of the second display device; and using a second video image capture device associated with the second display device to capture a third set of video image data of a second region of record including a second object; processing the third set of video image data to extract a second portion of video image data including the second object; sending the second portion of the video image data to the first display device; at the first display device, combining the second portion of video image data with a fourth set of video image data to form a second composite video image including the second object; and displaying the second composite video image on the second display device; wherein the second portion of video image data is displayed in the fourth composite video image with an apparently fixed position within the fourth set of video image data and a second variable orientation, the second variable orientation being based at least in part on movement of the second display device.

In a seventh aspect, the present disclosure provides a two-way communication system comprising: a first video image capture device associated with a first display device and arranged to capture a first set of video image data of a first region of record including a first object; first image processing means arranged to process the first set of video image data to extract a first portion of video image data including the first object; first sending means arranged to send the first portion of the video image data to a second display device; the second display device comprising: a first combining means arranged to combine the first portion of video image data with a second set of video image data to form a first composite video image including the first object; and a first display means arranged to display the first composite video image; wherein the first portion of video image data is displayed in the first composite video image with an apparently fixed position within the second set of video image data and a first variable orientation, the first variable orientation being based at least in part on movement of the second display device; and a second video image capture device associated with the second display device and arranged to capture a third set of video image data of a second region of record including a second object; second image processing means arranged to process the third set of video image data to extract a second portion of video image data including the second object; second sending means arranged to send the second portion of the video image data to the first display device; the first display device comprising: a second combining means arranged to combine the second portion of video image data with a fourth set of video image data to form a second composite video image including the second object; and a second display means arranged to display the second composite video image; wherein the second portion of video image data is displayed in the fourth composite video image with an apparently fixed position within the fourth set of video image data and a second variable orientation, the second variable orientation being based at least in part on movement of the second display device.

In an eighth aspect, the present disclosure provides a method of generating an augmented reality image, the method comprising: capturing a first set of image data; processing the image data to extract a specific portion of the data; and subsequently overlaying the extracted data portion on a second set of image data.

In a ninth aspect, the present disclosure provides a method for a display device to maintain a relative position and scale of an augmented reality image within its overlaid background environment, as seen by a user of a display device displaying the augmented reality image, whilst the position of the display device is changed; the method involving anchoring the augmented reality image to a plane within the background environment, and changing the angle and pitch of the augmented reality image based on the movement of the display device.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following figures. The figures are illustrated by way of example and not by way of limitation. Elements illustrated in the figures are not necessarily drawn to scale. In the figures:

FIG. 1 shows an overview of a system according to an embodiment of the present invention;

FIG. 2 shows a flowchart of simplified pipeline of the application of the system;

FIG. 3 shows a simplified room setup with all the required elements necessary to capture the required video quality for producing the augmented reality hologram;

FIG. 4a shows an example of a video frame showing the raw video frame as recorded by an RGB camera;

FIG. 4b shows an examples of a video frame, showing the postprocess RGB and mask data;

FIG. 5 shows the detailed calculations required for colour and alpha channels performed during real-time processing;

FIG. 6 shows a simplified example of how the application works when tracking an image target marker in augmented reality;

FIG. 7 shows a simplified example of how the application works when using a detected ground plane in augmented reality;

FIG. 8 shows the calculations required to rotate the model as the display device moves;

FIG. 9 shows the approximate relative position of the virtual camera and the resulting hologram in the virtual space;

FIG. 10 shows an overview of a system according to another embodiment of the present invention.

### DETAILED DESCRIPTION

Specific embodiments of the invention will now be described with reference to the accompanying figures. Like elements in the various figures are denoted by like reference numerals for consistency. Embodiments of the present invention are described below by way of example only. These examples represent the best ways of putting the invention into practice that are currently known to the applicant, although they are not the only ways in which this could be achieved. The description sets forth the functions of the example and the sequence of steps for constructing and operating the example. However, the same or equivalent functions and sequences may be accomplished by different examples.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment. Furthermore, separate or alternative embodiments are not necessarily mutually exclusive of other embodiments.

The present disclosure includes a method of providing an augmented reality image comprising recording a subject image using a recording device, extracting and refining the subject image from the image using processing techniques, and then providing, either through live streaming, download, or other means, the extracted subject image to a display device to overlay over real world images. The method uses a novel algorithm to tether the image in place and rotate it as the display device moves, significantly reducing the size and complexity of the image required.

One objective of an embodiment of the invention is to provide a novel system that can inexpensively capture a single video of a target object, after which a model with the appearance of 3D is generated.

Additionally, another objective of the invention is to provide a novel method for streaming the model to the display device, including a method to achieve the desired processing in real-time, enabling the display device to show a model filmed in real time in augmented reality.

Furthermore, another objective of the invention is to provide multiple methods of displaying the model in augmented reality, including a novel method to tether the image to a ground plane (i.e., any convenient, flat, surface) and a method to display the model when tracking an image target market in augmented reality. Images are displayed on the display device together with a live camera view to create the illusion that the subject of the video (the model) are present in the field of view of the camera in real time. Augmented Reality (AR) refers to a technology where computer generated content, for example overlays, are integrated with images of a real-world environment. Overlays are commonly a visual, e.g., image, representation of text, icons, graphics, video, pictures or 3D models.

For the purpose of describing the invention, the term “model” is defined as one or more computer-generated images, videos, or holograms. In an embodiment of the invention, a model is created after single-angle video data is extracted, processed, and reconstructed by graphics processing algorithms (both known algorithms, as well as the Applicant's proprietary algorithms described subsequently herein) executed in a computer system or in a cloud computing resource comprising a plurality of networked and parallel-processing computing systems.

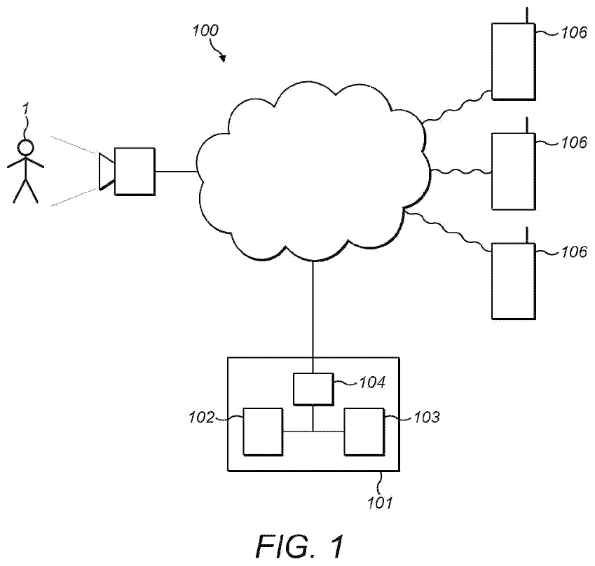

An overview of an augmented reality video distribution system 100 according to a first embodiment of the present invention is shown schematically in FIG. 1. The core of the augmented reality video distribution system 100 of FIG. 1 is a data processing and storage device 101, which may comprise a data processor 102, a data store 103 and a communications element 104. The data processing and storage device 101 may operate as a portal providing users and viewers with access to augmented reality video services.

An overview of operation of the augmented reality video distribution system 100 is that video data of an object 1 captured by a video camera 4 is sent through an electronic communications network, such as the Internet 105, to the data processing and storage device 101 for processing to produce a model, and in some examples for storage of the produced model. The processing produces the model by extracting a 2-dimensional (2D) video representation of the object 1 from the captured video. Further, in operation, the data processing and storage device 101 sends the model to one or more display devices or viewer devices 106 for display. The viewer device or display device 106 displays the 2D model in an augmented reality format to produce an augmented reality (AR) or virtual reality (VR) display by displaying the video model within an overlaid background environment with the orientation (angle and pitch), and optionally the size, of the displayed video model being changed based on movement of the viewer device or display device 106. This enables display of the object in an AR/VR format providing an illusion of three-dimensional (3D) display.

The model may be displayed on the display device 106 as a composite or overlay video image which overlays a video image of a real-world scene viewed by a camera of the display device 106 and rendered on a display of the display device 106. Accordingly, an AR display of the video model apparently present in a real world location visible to the user of the display device 106 can be provided.

The model may be displayed together with sound, such as speech. The sound may be recorded as part of the video data when the video data of the object 1 is captured, which may be particularly convenient if the object 1 is a human talking, and/or may be added to the video data subsequently.

The display devices 106 may be mobile phones, such as smartphones. Alternatively, the viewer devices 106 may be other mobile communications devices having a video camera and a means to display video images, such as a display screen.

Conveniently, the data processing and storage device 101 may be configured to operate as a server remotely accessed by users wishing to provide AR content, for example using the video camera 4, and users wishing to view AR content using display devices 106.

As is discussed in more detail below, the augmented reality video distribution system 100 may operate in real time, where the processed video data is sent immediately to a viewer device 106 for display, and may also operate in non-real time, where the processed video data is stored in the data store 103 of the data processing and storage device 101, and is sent to a display device 106 for display on request from the display device 106.

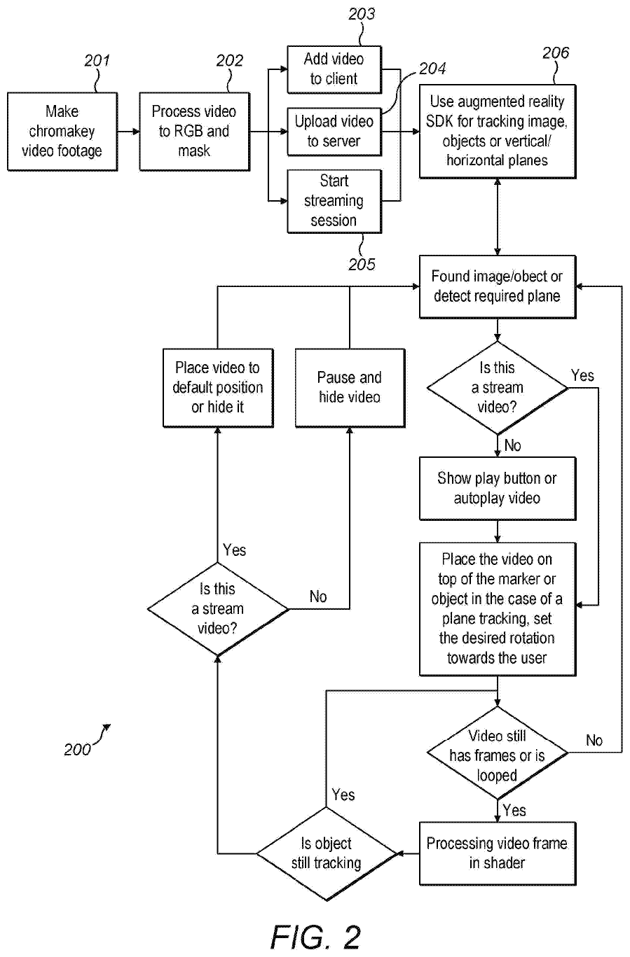

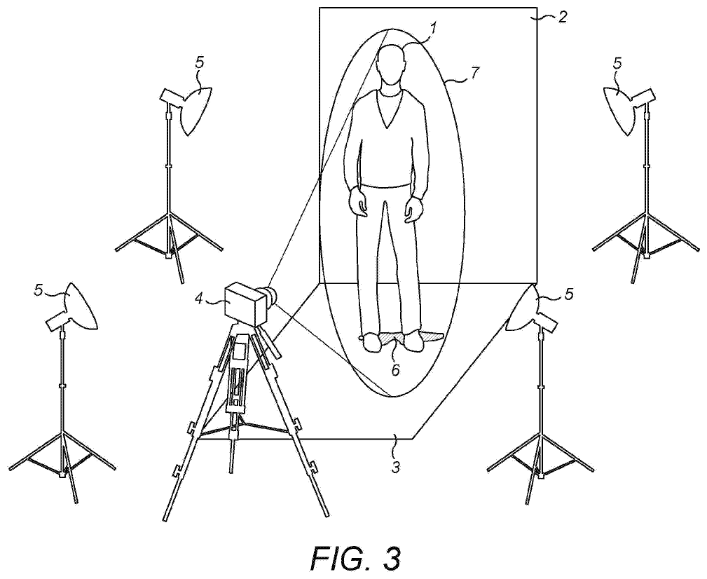

A flowchart of a video processing method 200 used in the first embodiment is shown in FIG. 2. Further, FIG. 3 shows a simplified room setup with all the required elements necessary to produce video data input having the required video quality to carry out the present invention according to the first embodiment. It will be understood that further elements, such as power supplies, may be required in practice, but these elements are omitted for clarity in FIG. 3. In the illustrated example of FIG. 3 the setup is configured to place a target object 1 in a designated region of record 7. In the illustrated example of FIG. 1 the target object 1 is a human, but different objects may be used in other examples, such as an animal or some other moving object. A Chroma Key (otherwise commonly referred to as a ‘green screen’) background 2 and Chroma Key floor 3 are positioned such that the Chroma key background 2 and Chroma key floor 3 extend beyond the edges of the region of record 7 in all directions.

A video recorder device or camera 4 is positioned to record a video image of the region of record 7 so that the target object 1 fills as much of the region of record 7 as possible, and lights 5 are arranged to provide an even illumination of the object 1 and to produce only a small shadow 6 of the object 1. The object 1 can move, but should stay within the region of record 7 defined by the field of view of the camera 4 and in front of the background 2 and floor 3 from the point of view of the camera 4. In this embodiment it is desirable for the object 1 to not include strong reflective colours or colours close to the colour of the background 2 and floor 3, as is usual in video applications when Chroma key is used.

The video recorder device or camera 4 can include any type of camera capable of recording the quality of video required in any specific application, including digital cameras and cameras of mobile phones or other mobile communications devices. In some examples a recording resolution is 4K may be preferred, but lower resolutions can also be used if desired. In the illustrated first embodiment the camera 4 is a conventional colour video camera, which may be referred to as an RGB video camera.

In a first video recording step 201 of the method 200, the video recorder device or camera 4 records the raw video data to produce a first set of video data including the target object 1. In the illustrated example the first set of video data is Chroma key video data or footage. The Chroma key video data is then sent to the data processing and storage device 101, and is processed in a process video step 202.

In the illustrated first embodiment the video processing may be carried out in non-real-time, or alternatively, may be carried out in real time.

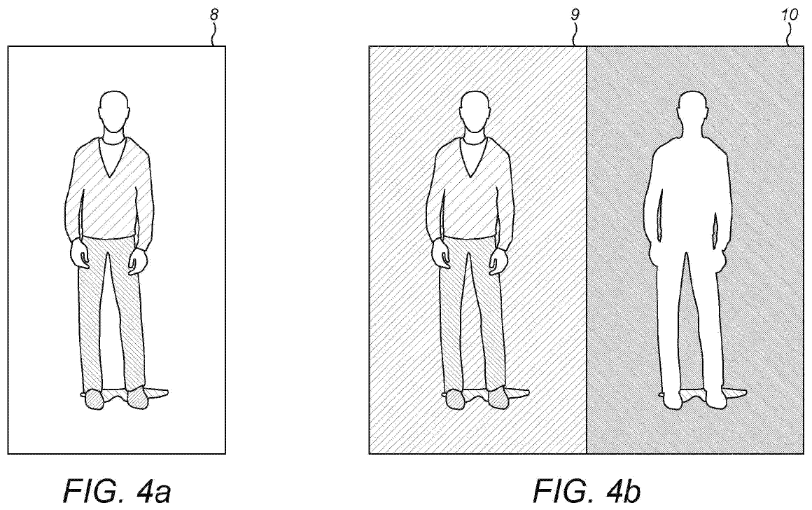

In one example of the first embodiment, the Chroma key video footage is processed by the data processing and storage device 101 in the process video step 202 to create a model comprising a processed portion of the first set of image data including the target object 1 using non-real-time processing. FIG. 4a shows a representation of the raw video frame 8 recorded by an RGB camera, while FIG. 4b shows on the left side and the right side separate representations of frames 9 and 10 of two separate video data streams created during the video processing in the process video step 802.

The left side of FIG. 2b shows a frame 9 of an RGB-video channel with colour data, but without flow and reflection from the background 2 and floor 3, and the right side of FIG. 2b shows a frame 10 of an alpha channel of black and white video with mask data based on colour from the background 2 and floor 3. This separation of the raw video into the separate channels represented by frames 9 and 10 may for example be carried out and achieved using either Adobe After Effects (Keylight) or Adobe Premier (Ultrakey). In other examples different video processing techniques may be used.

The video data of the separated channels is then processed in a shader. The shader may be provided as a software module on the data processing and storage device 101. The shader operates on each pixel of each frame of the video data. Data from the left side of the texture, that is, data corresponding to the frame 9, is converted to RGB output data and scaled by 0.5 (vertically) and the data from the right side of the texture, that is data corresponding to the frame 10, is converted to alpha channel data according to the intensity of the colour channel. The final video data for display is created using an alpha blending technique to combine the two separated video data channels. A threshold value may be used to discard pixels of the RBG video channel corresponding to pixels of the alpha channel with alpha values less than or equal to this threshold value to generate the final video of the model for display. The alpha value can be multiplied by a factor of the threshold values to create more realistic shadows or edges of hair and clothes. The resulting recombined video data corresponds to the model discussed above, and can be stored in many different locations; on the client device, on the server with the ability to download data for viewing without an Internet connection, or on the server with the ability to stream data using the Internet.

Preferably, the processing by the shader is arranged to retain a small area of natural shadow 6 on the floor around the target object 1 so that this shadow 6 is included in the final video of the model. Typically this shadow 6 is around the feet when the target object 1 is a human 1. This natural shadow 6 assists in making the model look real and acceptable to viewers.

In examples where the video data of the model is to be sent to a client device, such as one of the display devices 106, this is done in an add video data to client step 203. Alternatively, in examples where the video data of the model is to be stored on a server for subsequent access by a client device, such as one of the display devices 106, this is done in an upload video to server step 204. The server may conveniently be the data processing and storage device 101.

The use of an alpha channel approach according to the illustrated embodiment is a relatively data lean approach which may allow the amount of data transmitted when carrying out the method to be reduced.

An example of a pseudocode of a shader which may be used in an embodiment of the invention operating in non-real-time is set out below. The shader works on corresponding frames of the RGB video and the alpha channel mask (side by side).

fragment_shader( ) {

diffuse = texture_2d(input_diffuse_texture, vec2(uv_x * 0.5,
uv_y));

mask_color = texture_2d(input_diffuse_texture, vec2(uv_x * 0.5 +
0.5, uv_y));
output.color.rgb = diff.rgb * mask_color.r * ar_ambient.rgb;

output.color.a = mask_color.r;
if (a.r < threshold_mask) {

discard;

}

}

In the pseudocode:
fragment_shader—shader program executed for each pixel after rasterization of the object
input_diffuse_texture—incoming diffuse texture (in our case—video frame)
texture 2d—a function to display textures on the corresponding texture coordinates
uv_x and uv_y—x and y corresponding texture coordinates
ar_ambient—environment light from the AR library (optional)
output—outgoing structure
threshold_mask—minimum value for alpha channel (pixel discard)
discard—keyword for fragment shader that it shouldn't write any pixel

The non-real-time processing according to this example may be used by the data processing and storage device 101 to produce a video model of the object 1. This video model object can then be stored on a server for subsequent access by a client device, such as one of the display devices 106. The stored video model of the object is subsequently sent from the storage to a display device 106 for viewing on request. The server may conveniently be the data processing and storage device 101.

In another example of the first embodiment, the Chroma key video footage is processed in the process video step 202 to create a model comprising a processed portion of the first set of image data including the target object 1 using real-time processing.

In this example real-time processing is used to enable video streaming, which requires that the image is transmitted as quickly as possible. In this example the raw video from the RGB camera 4 is processed using a special shader that performs a similar function as the method described for the previous non-real-time example, but does so dynamically from the client side. For example, the video camera 4 may be incorporated in a client device such as a smartphone or similar mobile communications device, and an application may be provided on the client device that is configured to receive the raw data from a camera 4 of the device and is programmed with the necessary instructions to carry out the real-time processing method, so that the processing of the raw video data in the process video step 202 is carried out on the client device. However, it will be appreciated that it would be possible for the real-time raw video processing data in the process video step 202 described here to be carried out by a sever separate from the client device, such as the data processing and storage device 101, and transmitted to the client device once the processing has been carried out. In either case, once the resulting processed video data, such as the model, is available on the client device the client device can start a streaming session with a destination display device 106 in a start streaming session step 205. The resulting data is then streamed to the display device 106 for use in augmented reality. Streaming can work in real time including with compatible mobile devices, tablets, and other computers.

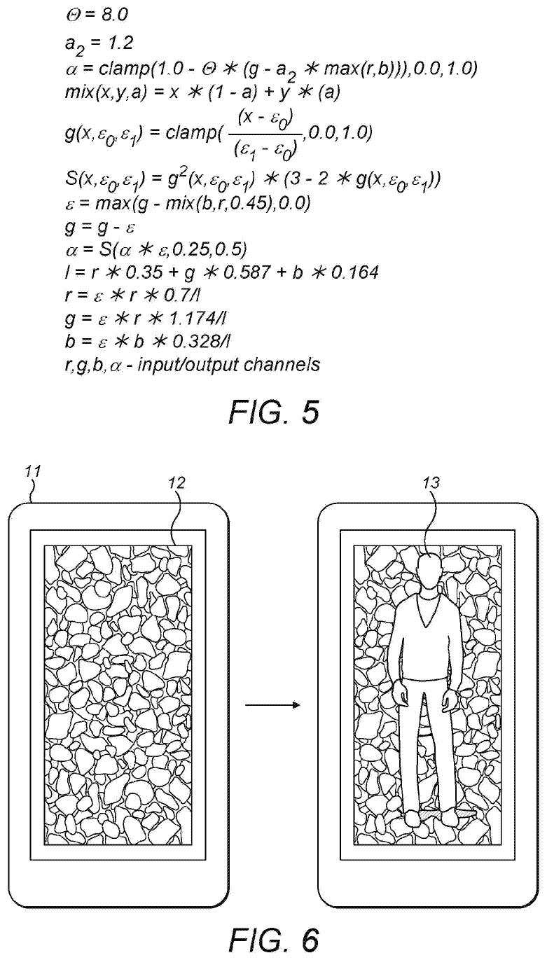

FIG. 5 shows the detailed calculations required for colour and alpha channels performed during real-time processing; this calculation must be performed for each pixel of each video frame. In summary, the detailed calculations that are carried out when implementing the algorithm of FIG. 5 are intended to cut out the desired data that will be used for the overlay—i.e., to remove the Chroma Key (green screen) colour background. As part of these calculations, any artifacts in the image that are a result of the Chroma Key colour background (e.g., glow, specularities, reflections) may be removed using this method, so as to generate a more realistic resultant image for overlay.

The method involves defining a set of variables that are subsequently utilised in the detailed calculations. Specifically, the α₂ and θ variables (in the first two lines of FIG. 5) are chosen depending on the brightness and contrast of the vides, and, r, b, g and a values (i.e., red, green, blue, alpha channels) are defined (final line of FIG. 5). Various functions are defined in lines 4 to 6 of FIG. 8, which are used to carry out certain calculations—for example the ‘max’ function returns the highest value of two numbers and the ‘g’ function normalises the value of x in the required interval. In addition, it should be noted that the ‘clamp’ function that is used in the these lines is a function that works in the following way (not explicitly defined in the figure): clamp(x, y, v) returns v if x<v<y; returns x if v<x; and returns y if v>y.

The equations on lines 3, 7, 8 and 10 then have the following functionality: the ‘α’ equation [line 3] computes the immediate alpha channel value, which depends on the ratio of the green colour to the largest of the other two channels; the ‘ε’ equation [line 7] calculates the relative contribution of green colour (in a given pixel); the ‘g’ equation [line 8] calculates the deviation of the green colour value from its normalised value; and the ‘l’ equation [line 10] calculates the illumination. Finally, the equations on lines 9, 11, 12 and 13 represent the calculations that are carried out to generate the output RGBA data for output and subsequent overlay.

An example of a pseudocode of a shader which may be used in an embodiment of the invention operating in real-time to carry out the calculations above is set out below. Similarly to the previous example of a non-real-time shader, the shader works on corresponding frames of the RGB video and the alpha channel mask (side by side).

chromakey_alpha(vec3 image_color, vec3 chroma_color,

float alpha_cutoff_min, float alpha_cutoff_max, float alpha_exponent,

float despill_cutoff_max, float despill_exponent) {

raw_comparison = length(abs(normalize(image_color) − normalize(pow(chroma_color,

2.2))));

alpha = clamp(pow(max(0.0, (raw_comparison − alpha_cutoff_min) / (alpha_cutoff_max −

alpha_cutoff_min)), alpha_exponent), 0.0, 1.0);

despill_alpha = clamp(1 − pow(max(0.0, (raw_comparison − alpha_cutoff_min) /

(despill_cutoff_max − alpha_cutoff_min)), despill_exponent), 0.0, 1.0);

return (alpha, despill_alpha, raw_comparison);

}
fragment_shader( ) {

color = texture_2d(input_diffuse_texture, vec2(uv_x, uv_y)).rgb;
result = chromakey_alpha(color, chroma_color, 0.4, 0.5, 1, 1, 1);
_output.color.rgb = color.rgb − color.rgb * normalize(chroma_color.rgb) * 0.15 * result.y;
_output.color.a = result.x;
if (result.x < threshold) {

discard;

}

}

### Here

chromakey_alpha—background color processing function
image_color—input image
chroma_color—background color input
alpha_cutoff_min—the minimum value for alpha clipping
alpha_cutoff_max—the maximum value for alpha clipping
alpha_exponent—additional power for alpha
despill_cutoff_max—the maximum values for clipping despill ( )
despill_exponent—additional power for despill
max—return the greater of two values
normalize—calculates the original vector
pow—return the value of the first parameter raised to the power of the second
clamp—constrain a value to lie between two further values
fragment_shader—shader program executed for each pixel after rasterization of the object
input_diffuse_texture—incoming diffuse texture (in our case—video frame)
texture_2d—a function to display textures on the corresponding texture coordinates
uv_x and uv_y—x and y corresponding texture coordinates
output—outgoing structure
threshold_mask—minimum value for alpha channel (pixel discard)
discard—keyword for fragment shader that it shouldn't write any pixel

The real-time processing according to this example may be used to produce a video model of the object 1 which can be streamed to a display device 106 for viewing. In some examples the raw video data may be sent by a content provider device incorporating the video camera 4 to the data processing and storage device 101, or another processing server, to carry out the processing and generate the video model. The generated video model can then be streamed to a target destination or returned to the content provider device for streaming. In other examples the processing may, for example, instead be carried out in a content provider device incorporating the video camera 4.

It should be noted that the video model of the object 1 is a conventional two-dimensional (2D) video, and accordingly will generally comprise less data than a three dimensional (3D) model of the object.

Depending on the use-case, either the real time or the non-real time processing method may be utilised. As will be appreciated, the real-time processing method is advantageously simpler and quicker to implement; it can therefore be used for overlaying augmented reality images in streamed videos without causing unacceptable delays. However, as this method is carried out in real time, no post-processing steps are carried out and hence any errors that arise during processing cannot be corrected before the processed data is streamed for use in augmented reality. In the case of non-real-time processing, post-processing to remove errors may be carried out, which may improve the quality of the model produced, but the entire processing method is much slower which hence would make it much more difficult to implement augmented reality during video streaming. Accordingly, either the real time or the non-real time processing method will be selected depending on whether or not the specific use case employs video streaming.

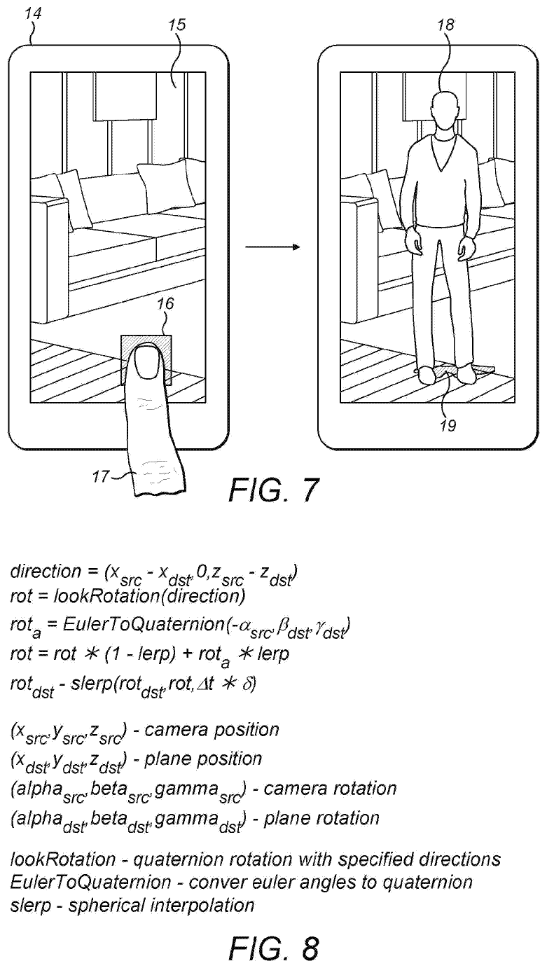

Once the display device has received the model it may be combined with a second set of image data to form a composite video image including the object and displayed in a display step 206 in an AR display on a plane, which can be located either over an image target (FIG. 6) or at an anchor point on the ground plane (FIG. 7), the image target or ground plane being visible in the video image which the model is to be added to in order to provide the AR display. Accordingly, the model/object is displayed at an apparently fixed position of the image or ground plane of the second set of image data.

In one embodiment, shown in FIG. 6, the display device 11, which is one of the display devices 106, uses an image target marker to place the plane on which the model 13 is displayed. This may be achieved using a typical AR image tracking algorithm, which may be selected depending on the libraries used for tracking. In summary, the image target marker can be any selected object or portion of the underlying image in a second set of image data that can be recognised by the algorithm, and which can be used to geo-locate the overlaid image (for example, via recognition of features/characteristics of the selected object, such as edges or shapes, by the algorithm). Typically, the underlying image (i.e., the second set of image data) is a video image of a real world environment captured by a video camera of the display device 11. Such video cameras are commonly incorporated in mobile communication devices such as mobile phones and the like.

In another embodiment, displayed in FIG. 7, the display device 14, which is one of the display devices 106, detects the ground plane in augmented reality. As previously mentioned, this ground plane is a flat surface within the underlying image, and may correspond to a flat horizontal or diagonally-oriented surface (for example, a floor or a hill/incline displayed within an image that the overlaid hologram may ‘walk’ or ‘stand’ on). The supported device 14 is positioned such that the augmented reality frame 15 includes the ground plane 16. The user's finger 17 touches the ground plane (touch zone) resulting in the recorded image 18 being displayed in augmented reality with required position and rotation plus shadow 19. Accordingly, the model/object is displayed at an apparently fixed position of the image or ground plane of the second set of image data. Typically, the underlying image (i.e., the second set of image data) is a video image of a real world environment captured by a video camera of the display device 11. Such video cameras are commonly incorporated in mobile communication devices such as mobile phones and the like.

A novel algorithm enables the display device to change the angle of the model according to the movement or position of the device, ensuring that even when the display device moves, the video model or hologram is displayed facing the user. This angle change may take place about a vertical axis, or about both vertical and horizontal axes. Display devices having a capability to sense movement of the display device are well known, and this is a standard feature of mobile communication devices such as smartphones and the like. Accordingly, it is not necessary to describe how the movement sensing is carried out in detail herein.

The size, scale and/or proportions of the displayed model/object may be varied based on the distance and position of the display device 14 from the location at which the model is apparently displayed (i.e., the location of the anchor point or geolocation of the displayed model).

FIG. 8 shows formulas which may be used in these calculations. In summary, these calculations involve dynamically correcting the rotation/orientation of the overlaid model, that is the hologram, relative to the user's viewpoint, as well as dynamically correcting perspective features and changing the proportions of the hologram to ensure that the overlaid image still looks realistic regardless of viewing angle. This is carried out by linking a ‘virtual camera’ (defined within the software algorithm and associated with the video/image displayed), and a ‘physical camera’ (a real camera that is provided within the display device), and determining on the basis of the orientation and location of the physical camera, the corresponding orientation and location of the virtual camera. In effect, the virtual camera mimics the position of the physical camera in the image/video frame.

It will be understood that although it is stated above that even when the display device moves, the video model or hologram is displayed facing the user, this may be more accurately be stated as the video model or hologram being displayed as if the user was viewing from the location of the camera which recorded the original video footage, for example the camera 4. In other words, the video model or hologram is displayed in an orientation corresponding to the orientation of the camera which recorded the original video footage. If the object 1 rotates relative to the original recording camera a corresponding rotation of the model will be displayed to the user.

As with FIG. 5, various variables and functions are defined in the calculations shown in FIG. 8. The central block of four lines defines the spatial position (in x, y, z spatial coordinates) and orientation (in α, β, γ Euler angle coordinates) of the virtual/physical camera and the plane within the image on which the hologram is displayed. The bottom block of three functions define various functions that are necessary for carrying out the detailed calculations—for example, conversions between Euler and Quaternion coordinate systems (EulertoQuaternion) that can be used to link the physical camera to the virtual camera, and hence determine how the movement of the physical camera should be interpreted as movement of he virtual camera. These functions may prevent the so called ‘billboarding’ effect which could otherwise reduce the quality of the displayed model by skewing the model about the horizontal and vertical axes to give a false perspective.

The top block of functions then sets out the calculations that are required to enable the overlaid hologram to rotate and maintain a realistic, accurate, perspective even if the display device (and hence the user's viewpoint/angle) is rotated. Specifically, the ‘direction’ function determines the movement (in the vertical plane in this case) between the virtual camera location and the ‘target plane’ of the hologram to determine how the virtual camera has moved relative to the target plane; the first ‘rot’ function calculates the resultant ‘look rotation’ from the hologram, plane to the virtual camera; the ‘rota’ function converts the Euler angles to the quaternion angles to determine any additional pitch alterations that have occurred as a result; the second ‘rot’ function mixes the calculated rotation and pitch alterations; and the ‘rot_{dst}’ function utilises spherical interpolation to generate a smooth rotation. It should be noted that the variable ‘Ierp’ used in these functions is responsible for providing the additional pitch rotation of the plane, necessary to reduce the effect of the incorrect projection of the hologram which may result in the lower part of the hologram seeming smaller than the upper part (e.g., a holographic person ending up with unnaturally small feet).

An example of a pseudocode for calculating a correct rotation of the mesh plane on which the model is displayed in the displayed video is set out below.

render( )
{

look_pos = camera.position − transform.position;
look_pos.y = 0.0f;
rotation = look_rotation(look_pos);
add_rotation = euler(vector(−camera.euler_angles.x,
rotation.euler_angles.y,

rotation.euler_angles.z));

rotation = lerp(rotation, add_rotation, calibration);
transform.rotation = slerp(transform.rotation, rotation, delta_time *
damping);

}

### Here

render—function runs every frame.
camera—object camera in augmented reality.
transform—the position of the mesh with the video
look_rotation—Creates a rotation with the specified directions forward.
vector—the vector with required coordinates
euler—Euler angles based on the required vector
lerp—linear interpolation
slerp—spherical interpolation
delta_time—time elapsed between frames
damping—a factor to speed interpolation factor
calibration—factor of calibration on the vertical axis

In a further embodiment, the methods displayed in FIG. 6 and FIGS. 7 & 8 can be combined. In this embodiment, the video display plane is calculated based on the target image, but if this is lost known target ground tracking algorithms are used to determine the relative position of the device. If the original target image is connected again, the position of the plane can be synchronized with the original. The flow diagram of FIG. 2 shows a simplified pipeline corresponding to this embodiment.

In another embodiment, the display of the model may be based upon a location of a trigger object visible in the field of view of a camera of the display device which generated the background for the AR display of the model. For example a trigger may be included in a magazine page or on a billboard which instructs a display device to access specific video model content from a server, such as the data processing and storage device 101, for display, and instructs the apparent location in a real world image of the trigger object where the video model is to be displayed as an AR display. For example on the trigger object or at a predetermined location relative to the trigger object.

This embodiment may be used, for example, to enable an on line version of a magazine to open a camera on a display device being used to view the on line magazine and show an AR display of a video model experience apparently placed on a flat surface visible to the camera.

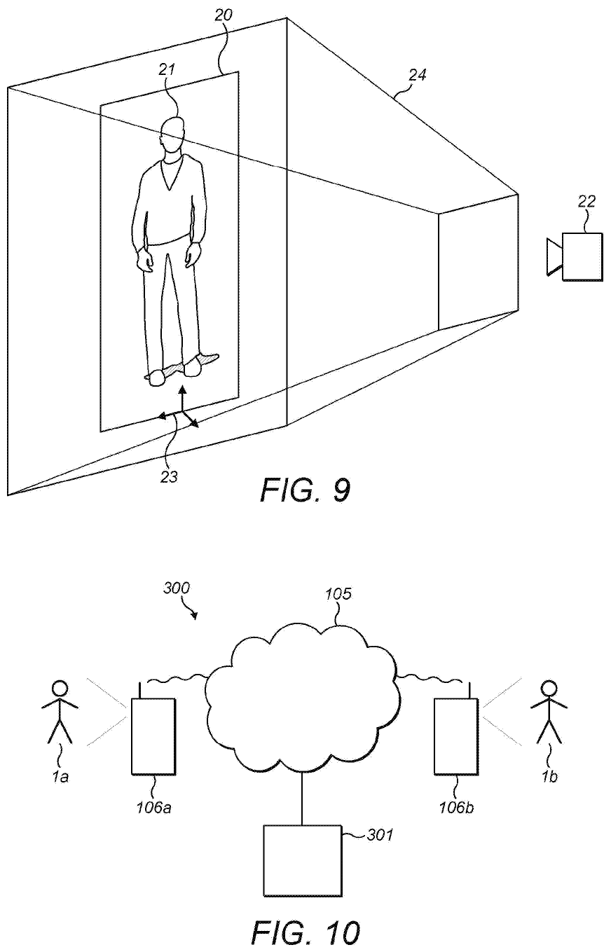

FIG. 9 shows the approximate relative position of the virtual camera and the resulting image in the virtual space. The image 21 is displayed on the mesh plane in 3d virtual space 20 according to the position of the virtual camera 22. The diagram also includes the axis which shows the possible rotation of the plane 23 and the virtual camera frustum 24.

The embodiments described above use green screen techniques to separate the desired model from other unwanted parts of the captured video image. Other image separation techniques may also be used.

In some alternative examples a depth camera may be used as the camera 4 capturing the initial raw video footage of the object 1 as an RGB-D video signal. In such examples where a depth camera is used a mask to separate out the object from other parts of the RGB video signal can be directly created from the depth image (i.e., the D signal part of the RGB-D video signal) by selecting parts of the image having an appropriate distance or depth from the RGB-D camera, and the colour channels do not require additional processing (i.e., the additional processing necessitated by the colour keying process). This mask can be used in a corresponding manner to the alpha channel signal in the illustrated embodiments described above to produce the model video data signal.

In the case where an RGB-D depth camera is used the resolution and accuracy of the depth camera are important, and the background is not important, that is, no green screen or other colour keying is necessary.

In some alternative examples a stereo camera may be used as the camera 4 capturing the initial raw video footage of the object 1 as two video signals, for example two RGB video signals. In such examples where a stereo camera is used the video signals from the stereo camera can be processed using parallax techniques to determine the distance or depth of different parts of the image, and this distance or depth information can be used to produce a mask to separate out the object from other parts of the RGB video signal can be directly created from the captured video image by selecting parts of the image having an appropriate distance or depth from the stereo camera, and the colour channels do not require additional processing (i.e., the additional processing necessitated by the colour keying process). This mask can be used in a corresponding manner to the alpha channel signal in the illustrated embodiments described above to produce the model video data signal.

In examples where a stereo camera is used the resolution and accuracy of the stereo camera are important, and the background is not important, that is, no green screen or other colour keying is necessary.

The use of a stereo camera may be preferred because smartphones incorporating stereo cameras are readily available, so this may allow content providers to avoid the cost and inconvenience of obtaining dedicated hardware to generate video content.

In some alternative examples a conventional video camera may be used, i.e., an RGB video camera, and machine learning techniques may be used to process the video signal from the camera and identify which parts of the video image correspond to an object of interest, such as a human. Once the relevant parts of the video image have been identified a mask can be produced and used to generate the video model in a similar manner to the depth camera and stereo camera examples discussed above.

The above description refers to the present invention being useable to provide an augmented reality (AR) display. However, the present invention can also be used to provide a virtual reality (VR) display. Virtual Reality (VR) refers to a technology where computer generated content, for example overlays, are integrated with other computer generated content. Accordingly, virtual reality may be regarded as a special case of augmented reality where the image being augmented has itself been computer generated. It will be understood that the only difference between an augmented reality display and a virtual reality display is the source of the image content which is combined with the overlay, which is of no significance for the present invention.

In some examples, when the video model is displayed it may be preferred to correct the apparent level of the ambient light of the video model based on the background light level of the video image on which the video model is overlaid to produce the AR display output. Conveniently, this may be done by taking the value of the ambient light level of the video model and multiplying by a coefficient derived from the background light level to determine the light level to be used for display of the video model.

In examples where the video model is displayed together with sound associated with the video model, such as speech, this sound may be generated with a volume corresponding to the apparent location of the video model in the AR display, for example by reducing the sound volume when the video model appears to be further away, to enhance realism.

In examples where the video model is displayed as a part of an AR display on a display device able to produce 3D sound, any sound associated with the video model, such as speech, may be generated to have an apparent source corresponding to the apparent location of the video model in the AR display, to enhance realism.

As can be understood from the above description the use of the disclosed techniques may provide solutions to the problems previously encountered in providing AR and/or VR displays.

As is explained above, the present disclosure may allow the amount of data which must be transmitted, and/or the required data transfer rates in streaming applications, to be reduced. Previous approaches require amounts of data and data rates which are too large for deployment to smartphone and other devices over the internet, for example using 3G/4G/WiFi, making photo-realistic quality not possible, and making streaming of either pre-recorded or live-streamed content impossible. For example, typical applications the streaming data rate required may be reduced from 1 GB+/minute to 60 mb/minute or less.

Further, the present disclosure may allow the required processing time to create an overlay video object or asset having sufficient quality to be accepted as photo-realistic to be reduced. In order to create a photo-realistic experience previous approaches require lengthy processing, in some-cases over 1 day in rendering time. This affects cost, deployment time and restricts the scale of deploying assets (frequency of asset creation). Furthermore this eliminates their potential to stream content in real-time. The present disclosure enables asset conversion that is near instantaneous allowing for the quick and cost effective deployment of assets at scale (frequency) because the majority of the asset processing may performed in real-time on the cloud or device itself. This also unlocks the ability to stream content in real-time.

Further, the present disclosure may allow the cost of content creation of an overlay video object or asset to be reduced. Using conventional techniques the cost of content creation is expensive (typically around GB£ 5,000-25,000/per asset) which is a massive inhibitor of deploying human assets into augmented and virtual reality at scale. The present disclosure enables asset creation at a price point which may be less than GB£ 250/per asset (generally GB£ 25-250/per asset) allowing for the creation of long term communications and storytelling to occur in this medium due to a more manageable price-point for content creators.

Further, the present disclosure may enable a better quality of experience. Quality of experience using known techniques is downgraded through postprocessing methods which are necessary for the capture methods used (pixel washing, image stitching, reducing size for deployment). The present disclosure retains original content capture quality, as the RGB video itself does not require any post-product processing in order to create the experience. The quality of experience of a human asset is of vital importance when used as a communications tool (for AR/VR) due to the psychological ‘Uncanny Valley’ effect which relates to a receiver/consumer's perception of interacting with a human-like object (in this case AR/VR depictions of humans). The primal instinct of acceptance/rejection of the experience determines the success or failure of using AR/VR as a communications medium. The present disclosure, by providing a higher quality experience than previous approaches may successfully create an experience perceived as being outside of the Uncanny Valley—something that has not been achieved by previous approaches.

A first use case type of the embodiments described above is for the data processing and storage device 101 to operate as a portal to a stored library of pre-recorded video models. In this type of use case content providers can record video of humans or other objects, for example using video cameras 4, and send this video to the data processing and storage device 101 for processing into a video object and storage of the video object. When a user consumer wishes to view one of the video objects, for example using a display device 106, the user can request download or streaming of the video object to their display device for display. Use of the system may be limited to authorized content providers and consumer users as appropriate using conventional access control techniques. In some examples it may be desired to only control the placing of content onto the data processing and storage device by content providers but to allow free access by consumer users.

Data stored on the data processing and storage device 101, such as video models, and video data transmitted between different devices, may be protected by known techniques, such as encryption.

It should be understood that the processing and storage functions may be separated and carried out by different devices. In some examples content providers may generate the video objects themselves and send them to a store.

The first type of use case may, for example be used in fashion retail, for example by integration with a mobile sales app for the sale of garments, for new fashion line release marketing events, for in-store appearance (for example by scanning an in store barcode to see an experience using a model), or for a Fashion Week event. Further, the first type of use case may, for example be used in sports, for example in merchandising, fan engagement, to provide additional content for matches (for example to supplement a broadcast), to provide in stadium experiences, or as part of a Hall of fame or museum exhibits. Further, the first type of use case may, for example be used in education, for example to provide marketing experiences, to provide teaching aids, to deliver textbook additional content, or as a mechanism for delivering recorded lectures. Further, the first type of use case may, for example be used in industrial training, for example in providing induction and training materials, to provide training which can be rolled out across multiple locations (for example worldwide), or to provide mass on demand training, for example for factory workers. Further, the first type of use case may, for example be used in broadcast media, for example to provide additional content for TV shows, to support marketing events, to deliver sign language deployment, to deliver newsroom content and/or content from reporters in the field. Further, the first type of use case may, for example be used in the adult entertainment industry, for example to, to provide prerecorded immersive video. Further, the first type of use case may, for example be used in the music industry, for example to provide music videos. Further, the first type of use case may, for example be used in a number of disruptive industries, for example to put human guides into software, to enable accommodation hosts to pitch their accommodation, to allow travel guides and sites to deliver pitches for and reviews of travel experiences, and to allow real estate agents to pitch properties.

A second use case type of the embodiments described above is for content providers to provide streaming video models. In this type of use case content providers can stream video of humans or other objects, for example using video cameras 4, process the video in real time or near real time, for example on a mobile communication device such as a smartphone, tablet computer or laptop, and send this streamed video model a user consumer for viewing, for example using a display device 106. It should be understood that the processing and streaming may be carried out by different devices. In some examples content providers may send video data to a server such as the data processing and storage device 101 for processing and return of the video model for streaming, or may send the video model to another device, such as a server, for streaming.

The second type of use case may, for example be used in fashion retail, for example by a mobile sales app to provide a private shopping experience, to stream influencer events, or to provide a Fashion Week live stream. Further, the second type of use case may, for example be used in sports, for example to capture and report press conferences and live messages, and pre-match notes. Further, the second type of use case may, for example be used in education, for example in delivering live lectures, and providing live conference keynote speeches. Further, the second type of use case may, for example be used in industrial training, for example to provide live remote assistance. Further, the second type of use case may, for example be used in broadcast media, for example to provide live content from a newsroom or reporters in the field. Further, the second type of use case may, for example be used in the adult entertainment industry, for example to provide live immersive video content. Further, the second type of use case may, for example be used in the music industry, for example to provide live music performances.

The above listed use cases are purely exemplary and are not intended to be exhaustive.

A further embodiment of the present invention is shown schematically in FIG. 10.

FIG. 10 shows a video distribution system 300. The system 300 comprises first and second display devices 106a and 106b each comprising at least one video camera and a video display. The first and second display devices 106a and 106b may be mobile phones, such as smartphones. Alternatively, the first and second display devices 106a and 106b may be other mobile communications devices having a video camera and a means to display video images, such as a display screen. The first and second display devices 106a and 106b are in mutual two way communication with one another through an electronic communications network, such as the Internet 105.

In operation of the video communication system 300 the users of the first and second display devices 106a and 106b are able to carry out mutual two way communication in which each user is able to view an augmented reality or virtual reality representation of the other user on their respective display device 106a or 106b.

The first display device 106a is arranged to use its at least one video camera to capture video data of a first object 1a, typically a human user of the first display device 106a, and to process the captured video data in the same manner as described above in the previous embodiments for the real-time processing example to produce a video model of the first object 1a. The first display device 106a then streams the video model to the second display device 106b through the Internet 105.

The second display device 106b then displays the video model to a user of the second display device 106b as an augmented reality (AR) display or a virtual reality (VR) display in the same manner as described above in the previous embodiments. Conveniently, the second display device 106b may display the video model of the first object 1a as an augmented reality (AR) display overlaid on a video image of the real world environment local to the second display device 106b captured by the at least one video camera of the second display device 106b.

Similarly, the second display device 106b is arranged to use its at least one video camera to capture video data of a second object 1b, typically a human user of the second display device 106b, and to process the captured video data in the same manner as described above in the previous embodiments for the real-time processing example to produce a video model of the second object 1b. The second display device 106b then streams the video model to the first display device 106a through the Internet 105.

The first display device 106a then displays the video model to the user of the first display device 106b as an augmented reality (AR) display or a virtual reality (VR) display in the same manner as described above in the previous embodiments. Conveniently, the first display device 106a may display the video model of the second object 1b as an augmented reality (AR) display overlaid on a video image of the real world environment local to the first display device 106a captured by the at least one video camera of the first display device 106a.

Thus, each user is able to simultaneously view an AR/VR display of the other user, enabling two way real time communications. This may be used, for example, to enable remote virtual meetings, videoconferencing, and the like.

In order for the two way communication to be of acceptable quality it is desirable that the delay or latency caused by data processing between capture of the video at one display device 106 and viewing of the AR/VR display at the other display device is as short as possible. It is preferred that this delay or latency be less than 300 milliseconds. It may be preferred for the total delay caused by both data processing and signal delays in transmission be less than 300 milliseconds.

In an alternative example the video communication system 300 further comprises a data processing device 301. In this example the first and second display devices 106a and 106b communicate via the data processing device 301 instead of communicating directly with one another. This may be desirable so that some or all of the processing of the captured video data to produce a video model may be carried out by the data processing device 301 instead of being carried out by one of the display devices 106a and 106b. Further, this may be desirable so that the data processing device 301 can support the video streaming. In some examples one of the display devices may send video data via the data processing device 301 while the other display device sends video data directly, depending on the different processing capabilities of the different display devices.

In the illustrated embodiment of FIG. 10 it may be preferred for the first and second display devices 106a and 106b to each have multiple cameras facing in different directions so that one camera can capture an image of an object while a second camera captures an image of the local real world environment. Such camera arrangements are common in mobile communication devices such as smartphones and tablet computers.

The illustrated embodiment of FIG. 10 has two viewing devices. In other examples more than two viewing devices may be used to enable more complex multi party communications.

In the illustrated embodiment of FIG. 10 viewing devices with integral cameras used to capture video of the object are used. It is expected that this will a useful arrangement, enabling conventional communication devices such as smartphones to be used. In other examples a viewing device may be used in cooperation with a video camera or cameras separate from the viewing device.

In the illustrated embodiments the data processing and storage device is shown as a single device. In other examples the functionality of the data processing and storage device may be provided by a plurality of separate devices forming a distributed system. In some examples the data processing and storage device may comprise a distributed system with some or all parts of the system being cloud based.

In the illustrated embodiments the data store is a part of the data processing and storage device. In other examples the data store may be located remotely from the other parts of the data processing and storage device. In some examples the data store may comprise a cloud based data store.

In the illustrated embodiments the data processing and storage device receives video data, processes it to produce a model, and may then store the model. In other examples, where the system is operating in a non real time manner, the data processing and storage device may store the received video data for subsequent processing.

In some of the illustrated embodiments green screen Chroma key techniques are used. In other examples alternative forms of colour keying may be used.

In the illustrated embodiments an alpha channel technique is used to generate the video model from raw video data. In some examples it may be preferred to adjust the alpha channel data to generate an outline and/or shadow around the object 1 as part of the video model. This use of an outline may assist in making the model stand out from the background video when displayed as an overlay. The retention of some shadow, particularly around a human objects feet, may enhance the perceived realism of the video object.

In the illustrated embodiments an alpha channel technique is used to generate the video model from raw video data. In other examples a different technique may be used.

In the illustrated embodiments, in examples operating in non-real-time the raw RGB video is sent from the camera to the data processing and storage device for processing. In other examples operating in non-real-time the RGB video may be processed to generate the model by processing means associated with the camera and the resulting model sent to the data processing and storage device. Such a processing means associated with the camera may be incorporated into a device together with the camera, such as the processor of a smartphone or similar mobile communications device, or may be a separate device.

In the illustrated embodiment the communication network is the Internet. In alternative examples other networks may be used in addition to, or instead of, the Internet.

In the embodiments described above the system may comprise a server. The server may comprise a single server or network of servers. In some examples the functionality of the server may be provided by a network of servers distributed across a geographical area, such as a worldwide distributed network of servers, and a user may be connected to an appropriate one of the network of servers based upon a user location. In alternative examples the system may be a stand alone system, or may be incorporated in some other system.

The above description discusses embodiments of the invention with reference to a single user for clarity. It will be understood that in practice the system may be shared by a plurality of users, and possibly by a very large number of remote users simultaneously.

The embodiment described above are fully automatic. In some alternative examples a user or operator of the system may instruct some steps of the method to be carried out.

In the illustrated embodiment the modules of the system are defined in software. In other examples the modules may be defined wholly or in part in hardware, for example by dedicated electronic circuits.

In the described embodiments of the invention the system 1 may be implemented as any form of a computing and/or electronic device.

Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

The computer executable instructions may be provided using any computer-readable media that is accessible by computing based device. Computer-readable media may include, for example, computer storage media such as a memory and communications media. Computer storage media, such as a memory, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media.

The term ‘computer’ is used herein to refer to any device with processing capability such that it can execute instructions. Those skilled in the art will realise that such processing capabilities are incorporated into many different devices and therefore the term ‘computer’ includes PCs, servers, mobile telephones, personal digital assistants and many other devices.

Those skilled in the art will realise that storage devices utilised to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realise that by utilising conventional techniques known to those skilled in the art that all, or a portion of the software instructions may be carried out by a dedicated circuit, such as a DSP, programmable logic array, or the like.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of preferred embodiments is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

### KEY

FIG. 1
1. Person (object).
4. Video recorder (camera, mobile device, etc).
100. augmented reality video distribution system.
101. data processing and storage device.
102. data processor.
103. data store.
104. communications element.
105. Internet.
106. display device.
FIG. 2
200 video processing method.
201. video recording step.
202. process video step.
203. add video data to client step.
204. upload video to server step.
205. start streaming session step.
206. display step.
FIG. 3
1. Person (object).
2. Chroma Key background.
3. Chromakey floor.
4. Video recorder (camera, mobile device, etc).
5. Lights providing uniform illumination and a small shadow.
6. Small shadow from object.
7. Region of record.
FIG. 4a
8. Raw frame.
FIG. 4b
9. RGB color frame with gray dark background.
10. Black and white mask frame.
FIG. 6
11. Supported device.
12. Target image in augmented reality.
13. Resulting image over target image.
FIG. 7
14. Supported device.
15. Augmented reality frame.
16. Touch zone (hit ground plane).
17. User finger.
18. Resulting image in augmented reality (with required position and rotation).
19 Shadow of object.
FIG. 9
20 Mesh plane in 3d virtual space with required frame data (processed by the necessary shader). It has rotation toward the camera (p.3) along the vertical axis and limited (it can be configured) rotation toward to camera along the horizontal axis.
21. Resulting image after shader processing.
22. Virtual camera in 3d scene.
23. Axis which show the rotation of the plane.
24. Virtual camera frustum.
FIG. 10
1a. First Person (object).
1b. Second Person (object).
105. Internet.
106a. First display device.
106b. Second display device.
300. video communication system.
301. data processing device.

1.-14. (canceled)

15. A method of displaying a video image, the method comprising:
receiving first set of video image data;
combining the first set of video image data with a second set of video image data to form a composite video image; and
displaying the composite video image on a display device;
wherein the first set of video image data is displayed in the composite video image with an apparently fixed position within the second set of video image data and a variable orientation, the variable orientation being based at least in part on movement of the display device.

16. The method according to claim 15, wherein the variable orientation is varied to display the first set of video image data with a fixed orientation relative to the display device.

17. The method according to claim 16, wherein the first set of video image data was captured using a first camera capturing a video image data of a region of record, and the variable orientation is varied to display the first set of video image data with an orientation relative to the display device which corresponds to the orientation of the region of record relative to the first camera.

18. The method according to claim 15, wherein the variable orientation is about a vertical axis.

19. The method according to claim 18, wherein the variable orientation is about both vertical and horizontal axes

20. The method according to claim 15, wherein the first set of video image data is displayed overlying the second set of video image data.

21. The method according to claim 15, wherein the second set of video image data is captured by a camera incorporated in the display device.

22. The method according to claim 15, wherein the composite video image comprises an augmented reality video image.

23. The method according to claim 15, wherein the first set of video image data is two-dimensional ‘2D’ video.

24. A system for generating a video image, the system comprising:
a video image capture device arranged to capture a first set of video image data of a region of record including an object;
image processing means arranged to process the first set of video image data to extract a portion of video image data including the object;
sending means arranged to send the portion of video image data to a display device;
the display device comprising:
combining means arranged to combine the portion of video image data with a second set of video image data to form a composite video image including the object; and display means arranged to display the composite video image on the display device;
wherein the portion of video image data is displayed in the composite image with an apparently fixed position within the second set of video image data and a variable orientation, the variable orientation being based at least in part on movement of the display device.

25. The system according to claim 24, wherein the variable orientation is varied to display the portion of video image data with a fixed orientation relative to the display device.

26. The system according to claim 25, further comprising a first camera arranged to capture the first set of video image data, wherein the variable orientation is varied to display the portion of video image data with an orientation relative to the display device which corresponds to the orientation of the region of record relative to the first camera.

27. (canceled)

28. The system according to claim 24, wherein the variable orientation is about both vertical and horizontal axes

29. The system according to claim 24, wherein the portion of the video image data is displayed overlying the second set of video image data.

30. The system according to claim 24, wherein the display device further comprises a camera arranged to capture the second set of video image data.

31. The system according to claim 24, wherein the composite video image comprises an augmented reality video image.

32. The system according to claim 24, further comprising storage means arranged to store the portion of the video image data; wherein the sending means are arranged to recover the portion of the video image data from the storage means and send the portion of the video image data to the display device.

33. (canceled)

34. (canceled)

35. The system according to claim 24, wherein the image processing means further comprises the sending means, and the sending means is arranged to stream the portion of video image data to the display device.

36. The system according to claim 24, wherein the region of record comprises a colour background and the image processing means is arranged to remove the colour background.

37.-38. (canceled)

39. The system according to claim 24, wherein the portion of video image data is two-dimensional ‘2D’ video.

40.-83. (canceled)
